(19) United States
(12) Patent Application Publication
(10) Pub. No.: US 2025/0200573 A1
(43) Pub. Date: Jun. 19, 2025

(54) EFFICIENT AND SECURE TOKEN PROVISIONING

(71) Applicant: Visa International Service Association, San Francisco, CA (US)

(72) Inventors: Trishell Menezes, San Francisco, CA (US); Jalpesh Chitalia, Redwood City, CA (US); Jan Jacobs, Pleasanton, CA (US)

(73) Assignee: Visa International Service Association, San Francisco, CA (US)

(21) Appl. No.: 18/847,108

(22) PCT Filed: Mar. 31, 2023
(86) PCT No.: PCT/US2023/017067

§ 371 Date: Sep. 13, 2024

Related U.S. Application Data
(60) Provisional application No. 63/342,839, filed on May 17, 2022.

(51) Int. Cl. G06Q 20/40

(52) U.S. Cl. CPC G06Q 20/401

(57) ABSTRACT

Enrollment data packet including device information of a user and resource provider information is received by a processing computer from an authorizing entity computer. The processing computer generates a token request push data packet including user information and the device information and transmits, to user device, the token request push data packet. The user device then transmits a request to initiate token provisioning to a resource provider computer associated with the resource provider information. Provisioning request generated based on the request to initiate the token provisioning is received by the processing computer from the resource provider computer and transmitted to a token service computer. The provisioning request includes the token request push data packet. Upon receiving the provisioning request, the token service computer determines token data using the device information and the user information and provides the token data to the resource provider computer.

### CROSS-REFERENCE TO RELATED APPLICATION(S)

This application is a PCT application claiming priority to U.S. Provisional Application No. 63/342,839, filed May 17, 2022, which is incorporated by reference herein in its entirety.

### BACKGROUND

Users can utilize tokens as substitutes for credentials in order to gain access to a service or a product. During a transaction, a token can be exchanged for a real credential (e.g., a primary account number (PAN) or some other payment information) that can be used in a transaction authorization process. Using tokens ensures greater security of sensitive information.

However, tokenization systems cannot keep up with the tokenization demands from users and/or resource providers. The number of tokens that have been generated in the recent years are in the billions, and this trend is predicted to continue.

Many resource providers are dependent upon associated service providers to implement tokenization and transaction processing. Due to the dependency, if the resource provider wishes to support new features such as push provisioning, the resource provider cannot do so until the service provider enables the technical changes to support the new features. However, the infrastructure needed to implement the new features involves additional resources and, thus, the service providers may be disinclined to make the required changes. This introduces a hindrance for the users and resource providers and creates a bottleneck in the tokenization processes.

Embodiments of the disclosure address the above-mentioned problems and other problems individually and collectively.

### SUMMARY

According to an aspect of an embodiment, a method is provided. The method includes receiving, by a processing computer from an authorizing entity computer, an enrollment data packet including device information of a user and resource provider information; generating, by the processing computer, a token request push data packet including user information and the device information; transmitting, by the processing computer to a user device, the token request push data packet, wherein the user device thereafter transmits a request to initiate token provisioning to a resource provider computer associated with the resource provider information; receiving, by the processing computer from the resource provider computer, a provisioning request generated based on the request to initiate the token provisioning; and transmitting, by the processing computer to a token service computer, the provisioning request including the token request push data packet, wherein, upon receiving the provisioning request, the token service computer determines token data using the device information and the user information from the token request push data packet, and provides the token data to the resource provider computer.

According to an aspect of an embodiment, a processing computer is provided. The processing computer includes a processor; and a computer-readable medium including code that, when executed by the processor, causes the processor to perform a method including: receiving, from an authorizing entity computer, an enrollment data packet including device information of a user and resource provider information; generating a token request push data packet including user information and the device information; transmitting, to a user device, the token request push data packet, wherein the user device thereafter transmits a request to initiate token provisioning to a resource provider computer associated with the resource provider information; receiving, from the resource provider computer, a provisioning request generated based on the request to initiate the token provisioning; and transmitting, to a token service computer, the provisioning request including the token request push data packet, wherein, upon receiving the provisioning request, the token service computer determines token data using the device information and the user information from the token request push data packet and provides the token data to the resource provider computer.

According to an aspect of an embodiment, a method is provided. The method includes transmitting, by a user device operated by a user to an authorizing entity computer, device information of the user and resource provider information of a resource provider, wherein the authorizing entity computer thereafter generates and transmits, to a processing computer, an enrollment data packet including the device information and the resource provider information; receiving, by the user device, a token request push data packet including user information and the device information; and in response to the receiving the token request push data packet, transmitting, by the user device a request to initiate token provisioning to a resource provider computer associated with the resource provider information, wherein the resource provider computer thereafter transmits, to the processing computer, a provisioning request generated based on the request to initiate the token provisioning, wherein the processing computer transmits, to a token service computer, the provisioning request including the token request push data packet, and wherein, upon receiving the provisioning request, the token service computer generates token data using the device information and the user information from the token request push data packet and provides the token data to the resource provider computer.

A better understanding of the nature and advantages of embodiments of the invention may be gained with reference to the following detailed description and accompanying drawings.

### BRIEF DESCRIPTION OF THE DRAWINGS

FIG. 1 shows a system and a swim-line flow diagram illustrating a method according to at least one embodiment.

FIG. 2 shows a simplified block diagram of a system according to at least one embodiment.

FIG. 3 shows a simplified block diagram of a system according to at least one embodiment.

FIG. 4 shows a simplified block diagram of a system according to at least one embodiment.

FIG. 5 shows a simplified block diagram of a user device according to at least one embodiment.

FIG. 6 shows a simplified block diagram of a token service computer according to at least one embodiment.

FIG. 7 shows a simplified block diagram of a processing computer according to at least one embodiment.

### DETAILED DESCRIPTION

Prior to discussing embodiments of the disclosure, some terms can be described in further detail.

An “application” may be computer code or other data stored on a computer-readable medium (e.g. memory element or secure element) that may be executable by a processor to complete a task.

An “access device” may be any suitable device that provides access to a resource. An access device may be in any suitable form. Some examples of access devices include vending machines, kiosks, POS or point of sale devices (e.g., POS terminals), cellular phones, PDAs, personal computers (PCs), tablet PCs, hand-held specialized readers, set-top boxes, electronic cash registers (ECRs), automated teller machines (ATMs), virtual cash registers (VCRs), Web servers, and the like. An access device may use any suitable contact or contactless mode of operation to transmit or receive data from, or associated with, a user mobile communication device. In some embodiments, an access device may include a reader, a processor, and a computer-readable medium. A reader may include any suitable contact or contactless mode of operation. For example, exemplary readers can include radio frequency (RF) antennas, optical scanners, bar code readers, or magnetic stripe readers to interact with a payment device and/or mobile communication device.

“Access data” may include any suitable data that can be used to access a resource or create data that can access a resource. In some embodiments, access data may be account information for a payment account. Account information may include a PAN, payment token, expiration date, card verification values (e.g., CVV, CVV2), dynamic card verification values (dCVV, dCVV2), an identifier of an issuer with which an account is held, etc. In other embodiments, access data could include data that can be used to access a location or to access secure data. Such information may be ticket information for an event, data to access a building, transit ticket information, passwords, biometrics or other credentials to access secure data, etc.

An “authorizing entity” may be an entity that authorizes a request. Examples of an authorizing entity may be an issuer, a government agency, a document repository, an access administrator, etc. An authorizing entity may operate an authorizing entity computer.

An “issuer” may refer to a business entity (e.g., a bank) that issues and optionally maintains an account for a user. An issuer may also issue payment credentials to the consumer that may be stored on a user device.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer.”

A “processor” may refer to any suitable data computation device or devices. A processor may include one or more microprocessors working together to accomplish a desired function. The processor may include a CPU including at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or XScale; and/or the like processor(s).

A “memory” may be any suitable device or devices that can store electronic data. A suitable memory may include a non-transitory computer-readable medium that stores instructions that can be executed by a processor to implement a desired method. Examples of memories may include one or more memory chips, disk drives, etc. Such memories may operate using any suitable electrical, optical, and/or magnetic mode of operation.

A “mobile communication device” may include any suitable electronic device that may be transported and operated by a user, which may also optionally provide remote communication capabilities to a network. Examples of remote communication capabilities include using a mobile phone (wireless) network, wireless data network (e.g., 3G, 4G, or similar networks), Wi-Fi, Bluetooth, Bluetooth Low Energy (BLE), Wi-Max, or any other communication medium that may provide access to a network such as the Internet or a private network. Examples of mobile communication devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile communication device may include any suitable hardware and software for performing such functions, and may also include multiple devices or components (e.g., when a device has remote access to a network by tethering to another device—i.e., using the other device as a modem—both devices taken together may be considered a single mobile communication device).

A “user” may include an individual. In some embodiments, a user may be associated with one or more personal accounts and/or user devices.

A “user device” may be a device that is operated by a user. Examples of user devices may include a mobile phone, a smart phone, a card, a personal digital assistant (PDA), a laptop computer, a desktop computer, a server computer, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. Example of the input sensors may include accelerometers, cameras, microphones, etc. The user input obtained by the input sensors may be from a variety of data input types, including, but not limited to, audio data, visual data, or biometric data. The user device may include any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “resource provider” may be an entity that can provide a resource such as goods, services, information, and/or access to a location (e.g., a parking space, a transit terminal, etc.). Examples of resource providers include merchants, government authorities, secure data providers, etc. A resource provider may operate one or more access devices.

A “resource provider computer” can be a computer operated by a resource provider. An example of a resource provider computer can be an access device.

A “credential” may be any suitable information that serves as reliable evidence of worth, ownership, identity, or authority. A credential may be a string of numbers, letters, or any other suitable characters that may be present or contained in any object or document that can serve as confirmation.

A “value credential” may be information associated with worth. Examples of value credentials include payment credentials, coupon identifiers, information needed to obtain a promotional offer, etc.

“Payment credentials” may include any suitable information associated with an account (e.g., a payment account and/or payment device associated with the account). Such information may be directly related to the account or may be derived from information related to the account. Examples of account information may include a bank account number, PAN (primary account number or “account number”), username, expiration date, CVV (card verification value), dCVV (dynamic card verification value), CVV2 (card verification value 2), CVC3 card verification values, etc. CVV2 is generally understood to be a static verification value associated with a payment device. CVV2 values are generally visible to a user (e.g., a consumer), whereas CVV and dCVV values are typically embedded in memory or authorization request messages and are not readily known to the user (although they are known to the issuer and payment processors). Payment credentials may be any information that identifies or is associated with a payment account. Payment credentials may be provided in order to make a payment from a payment account. Payment credentials can also include a username, an expiration date, a gift card number or code, and any other suitable information.

A “token” may be a substitute value for a credential. A token may be a string of numbers, letters, or any other suitable characters. Examples of tokens include access tokens such as payment tokens, data that can be used to access secure systems or locations, etc.

A “payment token” may include an identifier for a payment account that is a substitute for an account identifier, such as a bank account number, a primary account number (PAN), and/or an expiration date. For example, a token may include a series of alphanumeric characters that may be used as a substitute for an original account identifier. For example, a token “4900 0000 0000 0001” may be used in place of a PAN “4147 0900 0000 1234.” In some embodiments, a token may be “format preserving” and may have a numeric format that conforms to the account identifiers used in existing transaction processing networks (e.g., ISO 8583 financial transaction message format). In some embodiments, a token may be used in place of a PAN to initiate, authorize, settle or resolve a payment transaction or represent the original credential in other systems where the original credential would typically be provided. In some embodiments, a token value may be generated such that the recovery of the original PAN or other account identifier from the token value may not be computationally derived. Further, in some embodiments, the token format may be configured to allow the entity receiving the token to identify it as a token and recognize the entity that issued the token.

“Tokenization” is a process by which sensitive data is replaced with substitute data. For example, a real payment credential (e.g., a bank account number, a primary account number (PAN), etc.) may be tokenized by replacing the real account identifier with a substitute number that may be associated with the real credential. Further, tokenization can be applied to any other information to substitute the underlying information with a token. “Token exchange” or “de-tokenization” can be a process of restoring the data that was substituted during tokenization. For example, a token exchange may include replacing a payment token with its associated primary account number (PAN). Further, de-tokenization or token exchange may be applied to any other information to retrieve the substituted information from a token. In some embodiments, token exchange can be achieved via a transactional message, such as an ISO message, an application programming interface (API), or another type of web interface (e.g., web request).

A “token service computer” can include a system that that services tokens. In some embodiments, a token service computer can facilitate requesting, determining (e.g., generating) and/or issuing tokens, as well as maintaining an established mapping of tokens to payment credentials, e.g., bank account numbers or primary account numbers (PANs) in a repository (e.g., token vault). In some embodiments, the token service computer may establish a token assurance level for a given token to indicate the confidence level of the token to PAN binding. The token service computer may include or be in communication with a token vault where the generated tokens are stored. The token service computer may support token processing of payment transactions submitted using tokens by de-tokenizing the token to obtain the actual PAN.

A “token domain” may indicate an area and/or circumstance in which a token can be used. Examples of the token domain may include, but are not limited to, payment channels (e.g., e-commerce, physical point of sale, etc.), POS entry modes (e.g., contactless, magnetic stripe, etc.), and merchant identifiers to uniquely identify where the token can be used. A set of parameters (i.e., token domain restriction controls) may be established as part of token issuance by the token service computer that may allow for enforcing appropriate usage of the token in payment transactions. For example, the token domain restriction controls may restrict the use of the token with particular presentment modes, such as contactless or e-commerce presentment modes. In some embodiments, the token domain restriction controls may restrict the use of the token at a particular merchant that can be uniquely identified. Some exemplary token domain restriction controls may require the verification of the presence of a token cryptogram that is unique to a given transaction. In some embodiments, a token domain can be associated with a token requestor.

“Token expiry date” may refer to the expiration date/time of the token. The token expiry date may be passed among the entities of the tokenization ecosystem during transaction processing to ensure interoperability. The token expiration date may be a numeric value (e.g., a 4-digit numeric value). In some embodiments, the token expiry date can be expressed as a time duration as measured from the time of issuance.

A “token provisioning message,” e.g., a provisioning message, may be an electronic message for requesting a token. A token request message may include information usable for identifying a payment account or digital wallet, and/or information for generating a payment token. For example, a token request message may include payment credentials, mobile communication device identification information (e.g., a phone number or MSISDN), a digital wallet identifier, information identifying a tokenization service provider, a merchant identifier, a cryptogram, and/or any other suitable information. Information included in a token request message can be encrypted (e.g., with an issuer-specific key). In some embodiments, the token request message may include a flag or other indicator specifying that the message is a token request message.

A “token response message” may be a message that responds to a token request. A token response message may include an indication that a token request was approved or denied. A token response message may also include a payment token, mobile communication device identification information (e.g., a phone number or MSISDN), a digital wallet identifier, information identifying a tokenization service provider, a merchant identifier, a cryptogram, and/or any other suitable information. Information included in a token response message can be encrypted (e.g., with an issuer-specific key). In some embodiments, the token response message may include a flag or other indicator specifying that the message is a token response message.

An “authorization request message” may be a message that requests permission to conduct an interaction. For example, an authorization request message may include an electronic message that is sent to a payment processing network and/or an issuer associated with a payment credential to request authorization for a transaction. An authorization request message according to some embodiments may comply with International Organization of Standardization (ISO) 8583, which is a standard for systems that exchange electronic transaction information associated with a payment made by a consumer using a payment device or payment account. The authorization request message may include an issuer account identifier that may be associated with a payment device or payment account. An authorization request message may also include additional data elements corresponding to “identification information” including, by way of example only: a service code, a CVV (card verification value), a dCVV (dynamic card verification value), an expiration date, etc. An authorization request message may also include “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that an issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may include one or more computational apparatuses and may use any of a variety of computing structures, arrangements, and compilations for servicing the requests from one or more client computers. A server computer can be a cloud computer.

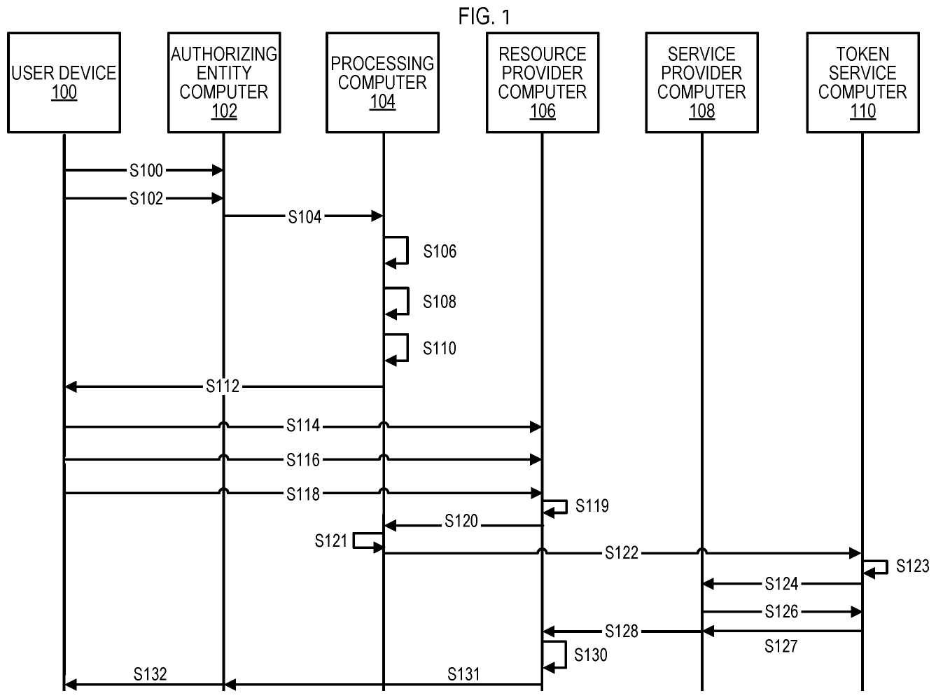

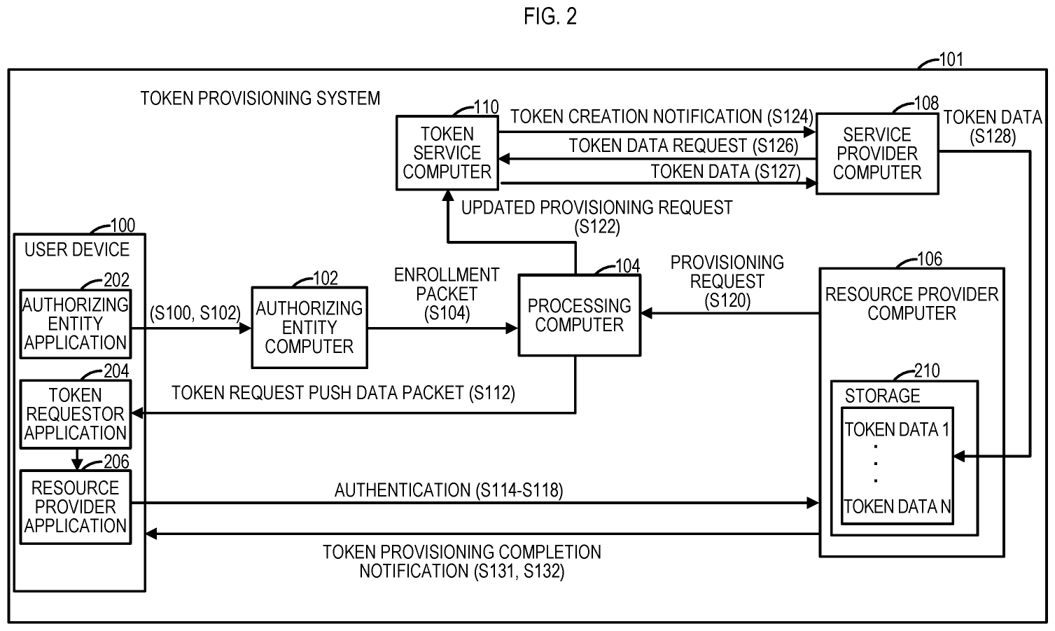

FIG. 1 shows a swim-line flow diagram illustrating a method according to an embodiment. FIG. 2 is a simplified block diagram of a token provisioning system 101 according to certain embodiments.

FIGS. 1 and 2 show a user device 100, an authorizing entity computer 102, a processing computer 104, a resource provider computer 106, a service provider computer 108, and a token service computer 110. In at least one example, the authorizing entity computer 102 may be operated by, or on behalf of an issuer (e.g., a financial institution associated with a payment credential of the user). In some embodiments, the resource provider computer 106 may be operated by a resource provider (e.g., merchant) that conducts recurring transactions. The service provider computer 108 may have a relationship with the resource provider computer 106. The processing computer 104 can be in communication with the authorizing entity computer 102 and the token service computer 110 to authorize activation and creation of the token.

Each of the entities shown in FIGS. 1 and 2 may communicate through any suitable communication channel or communications network. A suitable communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

However, as described below, in some instances, some of the entities might not have direct communication connection, e.g., communication relationship. For example, in certain implementations, the resource provider might not have a relationship with a token provider.

The user device 100 may be configured to receive input from the user that instructs the user device 100 to initiate a token provisioning process with the token service computer 110 to provision a token. In some embodiments, the user device 100 may be a mobile communication device of the user, which receives instructions from the user to provision a mobile communication device with a token.

In some embodiments, the user device 100 may execute a token requestor application, for example, a digital wallet, which may be responsible for requesting, storing, and/or managing one or more tokens received by the user device 100. In some embodiments, the user device 100 may also execute an application, e.g., an authorizing entity application 202 such as a mobile banking application, a cloud services application, a mass transit account application, etc. As example, the authorizing entity application 202 may be provided as a graphical user interface (GUI) on a display of the user device 100.

The authorizing entity application 202 may be responsible for transmitting an enrollment request to the authorizing entity computer 102 to initiate a provisioning process with the token service computer 110.

The processing computer 104 and the token service computer 110 may be computers affiliated with a token provider. The processing computer 104 and the token service computer 110 may facilitate requesting, determining (e.g., generating), and/or issuing tokens.

For example, the processing computer 104 may receive the enrollment request message from the authorizing entity computer 102. The processing computer 104 then can initiate processing and, as a result of processing, generate a token request push data packet. The processing computer 104 can transmit the token request push data packet to the user device 100, thereby invoking a token requestor (TR) application 204 on the user device 100. As example, the TR application 204 may be displayed as a GUI on the display of the user device 100. In some embodiments, the TR application 204 can be the same as the resource provider application 206 in FIG. 2, or it can be a different application that works in conjunction with the resource provider application 206.

The TR application 204 can facilitate the authentication of the user by the resource provider computer 106. The successful authentication results in the resource provider computer 106 transmitting a provisioning request to the processing computer 104. The processing computer 104 then can directly request issuance of the token for the user by communicating with the token service computer 110. The token service computer 110 can activate the token and inform the service provider computer 108 associated with the resource provider computer 106 about a token creation. The service provider computer 108 can then obtain the token data from the token service computer 110 and supply the token data to the resource provider computer 106. The token data can include a token and/or a token reference identifier.

The described techniques can provision a token for the user and the resource provider without involvement of the service provider operating the service provider computer 108. After the token is provisioned, the token data is released to the service provider computer 108 that may provide the token data to the resource provider computer 106.

According to the described techniques, the service provider computer of the service provider that is associated with the resource provider operating the resource provider computer is availed of the processing the request to provision the token to the user. As such, the described techniques overcome the problem of the related art where the provisioning request of the resource provider computer is routed to the token service computer via the service provider computer as an intermediary. In addition, the described techniques improve the functioning of the computer systems by reducing the computational resources and the network traffic.

With continuing reference to FIGS. 1 and 2, at operation S100, the user operating a user device 100 may transmit a login request to the authorizing entity computer 102, for logging in to the user account managed by the authorizing entity computer 102. For example, the user may access an application installed on the user device 100, e.g., an authorizing entity application 202, or access a website to transmit the login request. The login request may include the authentication information including at least one of a username, a password, and an account number associated with a user. The authorizing entity computer 102 may receive the login request, allow the user to log in, authenticate the user based on the authentication information, e.g., login credentials, and allow the user to log in and gain access to the user account.

After the user logs in to the user account managed by the authorizing entity computer 102, the user may select a primary account number (PAN) by selecting a card (e.g., a debit or credit card) and may select a resource provider, e.g., from a list of resource providers, using the user device 100. The selected resource provider may be an entity to which the user wishes to provision the token associated with the selected primary account number.

At operation S102, the user device 100 may transmit a data packet to the authorizing entity computer 102. The data packet can include information about the user-selected account and the user-selected resource provider, e.g., a primary account number and a name of a merchant.

Based on the data packet including the information about the user-selected primary account number and the user-selected resource provider from the user device 100, the authorizing entity computer 102 may generate an enrollment data packet for the authenticated user.

In some embodiments, the enrollment data packet may include information received in the data packet from the user device 100. For example, the enrollment data packet may include a device information of the user (e.g., a PAN or primary account number such as a credit, debit, or prepaid account number) and information relating to a user personal information (e.g., an email, phone number, and/or address of the user). The enrollment data packet may further include resource provider information, e.g., a name of a merchant, a merchant identifier, etc.

At operation S104, the authorizing entity computer 102 may transmit the enrollment data packet to a processing computer 104. The authorizing entity computer 104 may choose between a proxy or API.

At operation S106, after receiving the enrollment data packet from the authorizing entity computer 102, the processing computer 104 can determine a type of the resource provider based on the resource provider information in the enrollment data packet. For example, the processing computer 104 may determine whether the resource provider is an on behalf of (OBO) resource provider or a not-OBO resource provider. The OBO resource provider may have a relationship with the service provider operating the service provider computer 108, but no relationship with an entity that provisions tokens, e.g., the token service computer 110. The not-OBO resource provider may have a relationship with the service provider operating the service provider computer 108 and also with the entity that provisions tokens, e.g., the token service computer 110.

If, at operation S106, the processing computer 104 determines that the resource provider is the OBO resource provider, then the method proceeds to operation S108 where the processing computer 104 generates a token request push data packet formatted for the OBO resource provider. Otherwise, the method proceeds to operation S110 where the processing computer 104 generates a token request push data packet formatted for the not-OBO resource provider. The token request push data packet includes information including user information and the device information which may be variously generated for the OBO resource provider and the not-OBO resource provider, as described below.

In the case of the OBO resource provider, in operation S108, the processing computer 104 may validate the payment information of the user received in the enrollment data packet. For example, the processing computer 104 can check with the authorizing entity computer 102 to determine if the payment information such as the primary account number is a valid one and is not subject to any risk of fraudulent activity. The processing computer 104 then may generate a token request push data packet formatted for the OBO resource provider. For example, the processing computer 104 can encrypt the personal information and/or payment information of the user. The personal information of the user that is included in the token request push data packet formatted for the OBO resource provider may include at least some of the personal information provided in the enrollment data packet. The payment information of the user that is included in the token request push data packet formatted for the OBO resource provider may include at least some of the payment information provided in the enrollment data packet, e.g., four last digits and expiration date of a PAN.

In the case of the not-OBO resource provider, in operation S110, the processing computer 104 may validate the payment information of the user received in the enrollment data packet. For example, the processing computer 104 can check with the authorizing entity computer 102 to determine if the payment information such as the primary account number is a valid one and is not subject to any risk of fraudulent activity. The processing computer 104 may then generate the token request push data packet formatted for the not-OBO resource provider. For example, the processing computer 104 can encrypt the personal information and/or payment information of the user. The personal information of the user that is included in the token request push data packet formatted for the not-OBO resource provider may include at least some of the personal information provided in the enrollment data packet.

The payment information of the user that is included in the token request push data packet formatted for the not-OBO resource provider may be different from the payment information included in the token request push data packet formatted for the OBO resource provider. For example, the payment information provided in the token request push data packet formatted for the not-OBO resource provider may include a reference identifier corresponding to the primary account number of the user. For example, a non-OBO resource provider may use the reference identifier for the user's primary account number so that the non-OBO resource provider does not have access to the primary account number.

The processing computer 104 may store the token request push data packet for the user, together with the user-associated information.

At operation S112, after generating the token request push data packet, the processing computer 104 may transmit the token request push data packet to the user device 100. Upon receipt of the token request push data packet by the user device 100, the user device 100 can invoke the TR application 204 on the user device 100. In certain embodiments, the TR application 204 may include or have access to a resource provider application 206 associated with the resource provider selected by the user. As noted above, in some embodiments, the TR application 204 is the same as the resource provider application. The resource provider application 206 may provide a GUI on the display of the user device 100. E.g., receiving the token request push data packet by the user device 100 can invoke the resource provider application 206 on the user device 100.

At operation S114, after the TR application 204 is invoked, the user may access the resource provider application 206 managed by the resource provider computer 106. In response to the user device 100 accessing the resource provider application 206, the resource provider computer 106 can initiate an authentication process with respect to the user of the user device 100. In certain implementations, the resource provider computer 106 authenticates the user via the resource provider application 206, and based on authenticating the user, transmits, to the processing computer 104, the provisioning request that notifies the processing computer 104 that the resource provider computer 106 authorized an enrollment of the user.

For example, in response to the user accessing the resource provider application 206, the resource provider computer 106 can control the authentication process so that the authentication process is performed differently for a new user and a returning user, according to operation S116 and operation S118, respectively.

In operation S116, after accessing the resource provider application 206, the new user may create an account using the resource provider application 206. For example, the new user may input a username and password, along with other user information (e.g., name, address, phone number, email, etc.) into the resource provider application 206 to register for a resource provider account.

In operation S118, after accessing the resource provider application 206, the returning user may access an existing resource provider account in the resource provider application 206. For example, the returning user may log in to a resource provider account using authentication information, e.g., a username and a password.

After the new user successfully completes the registration or the returning user successfully logs in, the authentication process of the user by the resource provider computer 106 is successfully completed. The user, via the user device 100, may submit a request to provision the token associated with the user's primary account number to the resource provider application 206. In some embodiments, the request to provision the token to the resource provider application 206 may be a provisioning request to issue a token. In other embodiments, the request to provision the token to the resource provider application 206 may be a request to initiate a provisioning request to issue a token.

At operation 119, after receiving the request to provision the token from the user device 100, the resource provider computer 106 can generate a provisioning request. For example, the resource provider computer 106 may access user information to autofill the fields of the provisioning request. The resource provider computer 106 may access the user information input at the registration stage and stored in the user's account, to autofill the provisioning request. However, this is not intended to be limiting. In some embodiments, the resource provider computer 106 may request the user to manually input the user information into the fields of the provisioning request.

At operation S120, the resource provider computer 106 may transmit the provisioning request including the user information to the processing computer 104.

At operation S121, after receiving the provisioning request from the resource provider computer 106, the processing computer 104 may append additional data to the provisioning request to update the provisioning request. For example, the processing computer 104 may retrieve the token request push data packet corresponding to the user, based on the user information included in the provisioning request. The processing computer 104 then can append the data included in the token request push data packet to the provisioning request. For example, the processing computer 104 can append the device information including the primary account number from the token request push data packet to the provisioning request. In certain implementations, the processing computer 104 can also append the user information from the token request push data packet to the provisioning request.

At operation S122, the processing computer 104 may transmit the updated provisioning request to the token service computer 110.

At operation S123, after receiving the provisioning request from the processing computer 104, the token service computer 110 may generate or obtain a token, e.g., determine the token. For example, the token service computer 110 can tokenize the data in the token request push data packet to obtain a token. The token can be retrieved from a database of preexisting tokens or can be generated (e.g., mathematically) from the PAN.

After determining the token, the token service computer 110 may then generate a token creation notification. The token creation notification may include token information. The token information can include a provisioning request identifier, e.g., an identifier that uniquely identifies the provisioning request received from the processing computer 104 by the token service computer 110 and/or a token reference identifier that identifies the token determined for the user. In some embodiments, the resource provider computer 106 may provide the provisioning request identifier to the provisioning request upon creation of the provisioning request. However, this is not intended to be limiting. For example, the provisioning request identifier may be provided to the provisioning request by the processing computer 104 or the token service computer 110.

At operation S124, the token service computer 110 may transmit the token creation notification to the service provider computer 108.

At operation S126, after receiving the token creation notification from the token service computer 110, the service provider computer 108 may transmit a request, to the token service computer 110, to provide the token data including the token. For example, the request to provide the token data may include the token information from the token creation notification, e.g., a provisioning request identifier and/or a token reference identifier.

At operation S127, the token service computer 110 can transmit the token data to the service provider computer 108. The token data can include a token, a token reference identifier, a token expiration date, and/or a token cryptogram.

However, the described above is not intended to be limiting. In some embodiments, the service provider computer 108 may use an API to retrieve the token data from the token service computer 110 upon receiving the token creation notification from the token service computer 110.

At operation S128, after retrieving or receiving the token data from the token service computer 110, the service provider computer 108 may transmit the token data to the resource provider computer 106.

In some embodiments, since the service provider computer 108 does not actively participate in the token provisioning process, the token service computer 110 can determine the token that is formatted for the existing environment of the service provider computer 108.

At operation S130, after receiving the token data from the service provider computer 108, the resource provider computer 106 may store the token data in a storage 210 for future use, e.g., for future interaction or transaction with respect to the user. As shown in FIG. 2, the storage 210 may store a plurality of tokens and/or token data associated with the tokens for the same or at least partially different users.

However, the described above is not intended to be limiting. In certain implementations, the resource provider computer 106 may receive the token data from the token service computer 110.

At operation S131, the resource provider computer 106 may transmit a notification indicating a successful enrollment for the user, e.g., a token provisioning completion notification, to the authorizing entity computer 102. The token provisioning completion notification provides the indication that the token data for the user was successfully provided to and received by the resource provider computer 106.

At operation S132, the authorizing entity computer 102 may transmit the successful enrollment notification, e.g., the token provisioning completion notification, to the user device 100.

However, the described above is not intended to be limiting. In certain implementations, the resource provider computer 106 may transmit the successful enrollment notification to the user device 100, or to both the authorizing entity computer 102 and the user device 100.

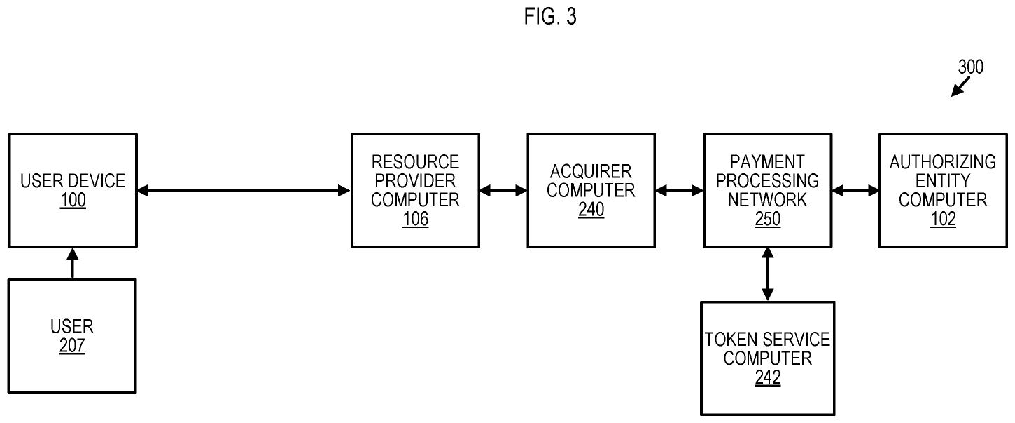

FIG. 3 shows a block diagram of a transaction processing system 300, which can be a system that can utilize the token that was provisioned, as described above, to the user device. FIG. 3 shows a user 207 that can operate a user device 100, e.g., a mobile communication device. The user 207 may use the user device 100 to pay for a good or service at a resource provider operating the resource provider computer 106, which stores the token data as described above. The resource provider may communicate with an authorizing entity computer 102 via an acquirer computer 240 and a payment processing network 250. A token service computer 242, similar to the token service computer 110 described above, can be in communication with the payment processing network 250. The payment processing network 250 can include the processing computer 104.

The payment processing network 250 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, transaction involving financial accounts, and other types of commercial transactions. VisaNet™, in particular, includes a VIP system (Visa

Integrated Payments system) which processes authorization requests and a Base II system which performs clearing and settlement services. The payment processing network may use any suitable wired or wireless network, including the Internet. In certain implementations, the processing computer 104 and/or the token service computer 110 may be a part of the payment processing network 250.

In a typical payment transaction flow, a user 207 uses the resource provider computer 106 to initiate a transaction with the resource provider operating the resource provider computer 106, or the resource provider computer 106 can initiate the transaction on behalf of the user 207 (e.g., as in a recurring payment transaction). The resource provider computer 106 may then generate an authorization request message with the stored token and additional transaction information (e.g., a transaction amount, merchant specific information, etc.) and can electronically transmit the authorization request message to an acquirer computer 240. The acquirer computer 240 may then receive, process, and forward the authorization request message to a payment processing network 250 for authorization.

Once the payment processing network 250 obtains the token, the payment processing network 250 can communicate with the token service computer 242 to obtain the credential associated with the token.

For example, prior to the occurrence of a credit or debit-card transaction, the payment processing network 250 has an established protocol with each issuer on how the issuer's transactions are to be authorized. In some cases, such as when the transaction amount is below a threshold value, the payment processing network 250 may be configured to authorize the transaction based on information that it has about the user's account without generating and transmitting an authorization request message to the authorizing entity computer 102, e.g., an issuer computer. In other cases, such as when the transaction amount is above a threshold value, the payment processing network 250 may receive the authorization request message, determine the issuer associated with the user device 100, and forward the authorization request message including the credential to the authorizing entity computer 102 for verification and authorization. Once the transaction is authorized, the authorizing entity computer 102 may generate an authorization response message (that may include an authorization code indicating the transaction is approved or declined) and transmit this electronic message via its external communication interface to payment processing network 250. The payment processing network 250 can then obtain the credential from the authorization response message, and can obtain the token from the token service computer 242. The payment processing network 250 can then modify the authorization response message to include the token instead of the credential.

The payment processing network 250 may then forward the authorization response message including the token to the acquirer computer 240, which in turn may then transmit the electronic message including the authorization indication to the resource provider computer 106.

At the end of the day or at some other suitable time interval, a clearing and settlement process between the resource provider computer 106, the acquirer computer 240, the payment processing network 250, and the authorizing entity computer 102 may be performed on the transaction.

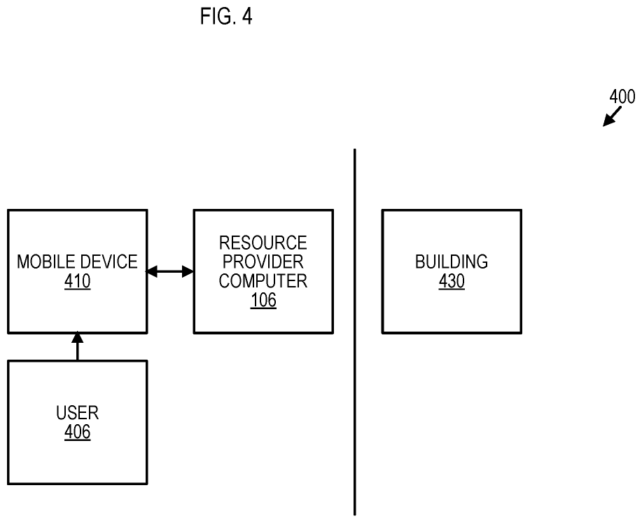

FIG. 4 shows a system 400 for using a mobile communication device 410 to gain access to a building 430 (e.g., may refer to any secure location) according to various embodiments. In yet other embodiments, the building may be a secure server computer that houses secure data to be accessed (e.g., secure and private data records). The mobile communication device 410 may correspond to the user device 100.

A user 406 can use a mobile communication device 410 to interact with the resource provider computer 106. For example, the resource provider computer 106 can retrieve the token or can request a token, as described with reference to FIGS. 1 and 2. The token may be sent to the building 430, which may exchange the token for a real credential (e.g., a PIN) which can be used to gain access to the building 430. The real credential can be used to identify the user 406, look up information about the user, and authenticate the user before allowing the user into the building 430.

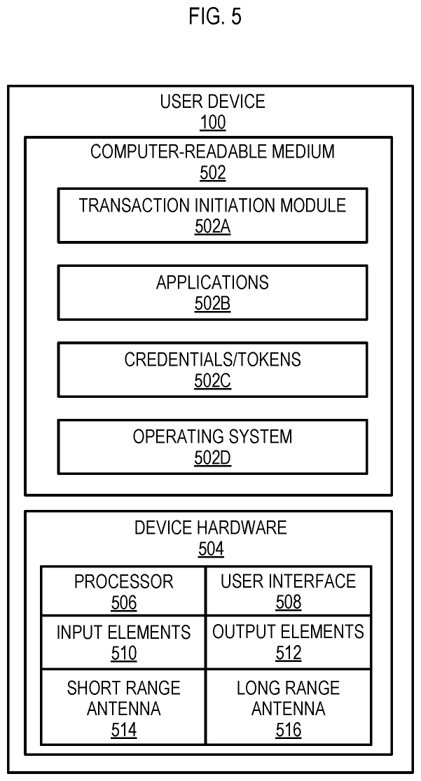

FIG. 5 shows a block diagram of a user device 100 that can be used in various embodiments. The user device 100 may be a mobile phone or an access card.

The user device 100 may include a computer-readable medium 502, which can be in the form of (or may be included in) a memory element that stores data (e.g., resource provider applications) and can be in any suitable form (e.g., microSD chip, SIM card, or other type of memory element). The computer-readable medium 502 may include a transaction initiation module 502A, one or more applications 502B, and an operating system 502D for the user device 100. The transaction initiation module 502A may begin a transaction at the request of a user or an application.

The user device 100 may further a storage element 502C storing real credentials and/or tokens. The storage element 502C may be a part of the computer-readable medium 502 or may be a secure memory element that is separate from the computer-readable medium 502, such that tokens or credentials can only be accessed or altered by certain elements of the user device 100 and/or outside devices.

In addition, the user device 100 may include device hardware 504, including a processor 506, a user interface 508, input elements 510, and output elements 512. The device hardware 504 may also include a long range antenna 516 and a short range antenna 514 for communicating with a wireless network and/or other devices. All elements in the device hardware 504 are operatively coupled, enabling mutual communication and data transfer.

The computer-readable medium 502 can store code, executable by the processor for implementing a method including: transmitting, to an authorizing entity computer 102, device information of the user and resource provider information of a resource provider, wherein the authorizing entity computer 102 thereafter generates and transmits, to a processing computer 104, an enrollment data packet including the device information and the resource provider information; receiving a token request push data packet including user information and the device information; and in response to the receiving the token request push data packet, transmitting a request to initiate token provisioning to a resource provider computer 106 associated with the resource provider information, wherein the resource provider computer 106 thereafter transmits, to the processing computer 104, a provisioning request generated based on the request to initiate the token provisioning, wherein the processing computer 104 transmits, to a token service computer 110, the provisioning request including the token request push data packet, and wherein, upon receiving the provisioning request, the token service computer 110 generates token data using the device information and the user information from the token request push data packet and provides the token data to the resource provider computer 106.

In some embodiments, the receiving the token request push data packet causes the user device 100 to invoke a resource provider application 206 associated with the resource provider computer 106 on the user device 100.

In some embodiments, the resource provider computer 106 authenticates the user via the resource provider application 206 and based on the authentication of the user, transmits, to the processing computer 104, the provisioning request, wherein the provisioning request notifies the processing computer 104 that the resource provider computer 106 authorized an enrollment of the user.

In some embodiments, the token data includes a token that is stored by the resource provider computer 106 to be used in a future interaction with respect to the user.

In some embodiments, the token data includes at least one from among a token reference identifier and a token corresponding to a primary account number of the user.

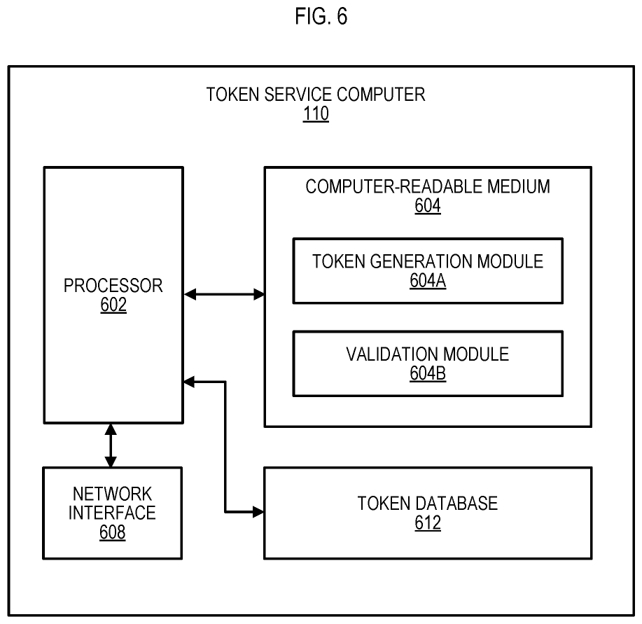

Referring to FIG. 6, a block diagram of a token service computer 110 according to various embodiments is illustrated. The token service computer 110 may include a processor 602 and a network interface 608 for receiving and transmitting messages (e.g., a provisioning request message, a token creation message, etc.) from/to outside sources (e.g., the authorizing entity computer 102, the service provider computer 108, the processing computer 104, etc.).

The token service computer 110 may include a non-transitory computer-readable medium 604, including a token generation module 604A and a validation module 604B. The token generation module 604A may include code, executable by the processor 602 to generate or obtain at least one token from an access credential. However, this module may also be substituted for a token retrieval module, which connects the token service computer 110 to an outside database (e.g., issuer or authorizing entity) that can provide at least one token. The validation module 604B may be used, in conjunction with the processor 602, to validate a token.

FIG. 6 also shows a token database 612 operatively coupled with the processor 602. The token database 612 may store tokens that are generated, along with other token data such as mapping to real credentials, cryptograms, etc.

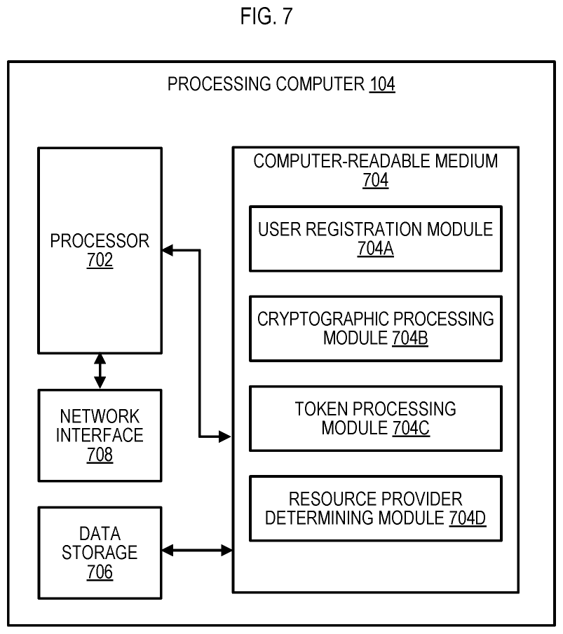

FIG. 7 illustrates a block diagram of a processing computer 104 according to embodiments.

The processing computer 104 may include a processor 702, a computer-readable medium 704, a data storage 706, and a network interface 708 coupled to the processor 702 for receiving and transmitting messages.

The computer-readable medium 704 can implement a user registration module 704A. The user registration module 704A can register, e.g., enroll, a user operating the user device 100. The user registration module 704A can map the user, e.g., the user information, PAN, etc., the authorizing entity, and the resource provider information. The user registration module 704A can store mappings between the above entities in the data storage 706.

The computer-readable medium 704 can also implement a cryptographic processing module 704B. The cryptographic processing module 704B can encrypt/decrypt user information and/or credentials for the user device 100 to implement the provisioning process as described herein.

The computer-readable medium 704 can also implement a token processing module 704C. The token processing module 704C can generate the token request push data packet. The network interface 708 can then transmit the token request push data packet to the user device 100, as described above. Also, the token request push data packet can be stored in the data storage 706 in association with a user identifier, e.g., PAN and/or other user-identifying information.

The token processing module 704C can, upon receiving the provisioning request from the resource provider computer 106 that authenticated the user, generate an updated provisioning request, by appending the token request push data packet to the provisioning request. The network interface 708 can then transmit the updated provisioning request to the token service computer 110 to obtain a token, as described above.

The updated provisioning request and the provisioning request identifier may be stored in the data storage 706, in association with a user identifier, e.g., PAN and/or other user-identifying information.

The computer-readable medium 704 can also implement a resource provider determining module 704D. The resource provider determining module 704D may determine whether the resource provider is an OBO resource provider or a not-OBO resource provider as described above.

The computer-readable medium 704 can also store code, executable by the processor 702 for implementing a method including: receiving, from an authorizing entity computer 102, an enrollment data packet including device information of a user and resource provider information; generating a token request push data packet including user information and the device information; transmitting, to a user device 100, the token request push data packet, wherein the user device 100 thereafter transmits a request to initiate token provisioning to a resource provider computer 106 associated with the resource provider information; receiving, from the resource provider computer 106, a provisioning request generated based on the request to initiate the token provisioning; and transmitting, to a token service computer 110, the provisioning request including the token request push data packet, wherein, upon receiving the provisioning request, the token service computer 110 determines token data using the device information and the user information from the token request push data packet and provides the token data to the resource provider computer 106.

In some embodiments, the authorizing entity computer 102 authenticates the user and generates the enrollment data packet based on the user being authenticated.

In some embodiments, the authorizing entity computer 102 authenticates the user by allowing the user to log in to a user account and evaluating login credentials of the user.

In some embodiments, the receiving the token request push data packet by the user device 100 invokes a resource provider application 206 on the user device 100.

In some embodiments, the resource provider computer 106 authenticates the user via the resource provider application 206, and based on authenticating the user, transmits, to the processing computer 104, the provisioning request that notifies the processing computer 104 that the resource provider computer 106 authorized an enrollment of the user.

In some embodiments, the resource provider information identifies a resource provider, and the method further includes: in response to receiving the enrollment data packet, determining whether the resource provider is an on behalf of (OBO) resource provider that is not in communication with the token service computer or a not-OBO resource provider that is in communication with the token service computer.

In some embodiments, the generating the token request push data packet further includes: in response to the determining the resource provider being the OBO resource provider, generating the token request push data packet to include the user information and the device information, wherein the device information includes a primary account number; and in response to the determining the resource provider being the not-OBO resource provider, generating the token request push data packet to include the user information and the device information, wherein the device information includes a reference identifier corresponding to a primary account number.

In some embodiments, prior to the transmitting to the token service computer 110 the provisioning request, the processing computer 104 appends the token request push data packet to the provisioning request received from the resource provider computer, to generate an updated provisioning request.

In some embodiments, the token data includes at least one from among a token and a token reference identifier.

In some embodiments, the token data includes the token that is 16 digits long.

In some embodiments, the at least one from among the token and the token reference identifier is stored by the resource provider computer 106 to be used in a future interaction with respect to the user.

In some embodiments, the token service computer 110 provides the token data to the resource provider computer 106 via a service provider computer 108, and, prior to the providing the token data to the service provider computer 108, the token service computer 110 generates a token creation notification including token information and provides the token creation notification to the service provider computer 108.

In some embodiments, the token information includes a provisioning request identifier identifying the provisioning request and a token reference identifier identifying a token.

In some embodiments, a resource provider associated with the resource provider information is selected by the user before the enrollment data packet is received by the processing computer 104.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer-readable medium, such as a random access memory (RAM), a read only memory (ROM), a magnetic medium such as a hard-drive or a floppy disk, or an optical medium such as a CD-ROM. Any such computer-readable medium may reside on or within a single computational apparatus, and may be present on or within different computational apparatuses within a system or network.

The above description is illustrative and is not restrictive. Many variations of the invention may become apparent to those skilled in the art upon review of the disclosure. The scope of the invention can, therefore, be determined not with reference to the above description, but instead can be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A method comprising:
receiving, by a processing computer from an authorizing entity computer, an enrollment data packet including device information of a user and resource provider information;
transmitting, by the processing computer to a user device, the token request push data packet, wherein the user device generating, by the processing computer, a token request push data packet including user information and the device information;
thereafter transmits a request to initiate token provisioning to a resource provider computer associated with the resource provider information;
receiving, by the processing computer from the resource provider computer, a provisioning request generated based on the request to initiate the token provisioning; and
transmitting, by the processing computer to a token service computer, the provisioning request including the token request push data packet, wherein, upon receiving the provisioning request, the token service computer determines token data using the device information and the user information from the token request push data packet, and provides the token data to the resource provider computer.

2. The method of claim 1, wherein the authorizing entity computer authenticates the user and generates the enrollment data packet based on the user being authenticated.

3. The method of claim 2, wherein the authorizing entity computer authenticates the user by allowing the user to log in to a user account and evaluating login credentials of the user.

4. The method of claim 1, wherein receiving the token request push data packet by the user device invokes a resource provider application on the user device.

5. The method of claim 4, wherein the resource provider computer authenticates the user via the resource provider application, and based on authenticating the user, transmits, to the processing computer, the provisioning request that notifies the processing computer that the resource provider computer authorized an enrollment of the user.

6. The method of claim 1, wherein:
the resource provider information identifies a resource provider, and the method further comprises:
in response to receiving the enrollment data packet, determining, by the processing computer, whether the resource provider is an on behalf of (OBO) resource provider that is not in communication with the token service computer or a not-OBO resource provider that is in communication with the token service computer.

7. The method of claim 6, wherein the generating the token request push data packet further comprises:
in response to the determining the resource provider being the OBO resource provider, generating the token request push data packet to include the user information and the device information, wherein the device information comprises a primary account number; and
in response to the determining the resource provider being the not-OBO resource provider, generating the token request push data packet to include the user information and the device information, wherein the device information comprises a reference identifier corresponding to a primary account number.

8. The method of claim 1, further comprising:
prior to the transmitting the provisioning request, appending, by the processing computer, the token request push data packet to the provisioning request received from the resource provider computer, to generate an updated provisioning request, wherein the provisioning request that is sent to the token service computer is the updated provisioning request.

9. The method of claim 1, wherein the token data comprises at least one from among a token and a token reference identifier.

10. The method of claim 9, wherein the token data comprises the token that is 16 digits long.

11. The method of claim 9, wherein the at least one from among the token and the token reference identifier is stored by the resource provider computer to be used in a future interaction with respect to the user.

12. The method of claim 1, wherein:
the token service computer provides the token data to the resource provider computer via a service provider computer, and
prior to the providing the token data to the service provider computer, the token service computer generates a token creation notification including token information and provides the token creation notification to the service provider computer.

13. The method of claim 12, wherein the token information includes a provisioning request identifier identifying the provisioning request and a token reference identifier identifying a token.

14. The method of claim 1, wherein a resource provider associated with the resource provider information is selected by the user before the enrollment data packet is received by the processing computer.

15. A processing computer comprising:
a processor; and
a computer-readable medium comprising code that, when executed by the processor, causes the processor to perform a method including:
receiving, from an authorizing entity computer, an enrollment data packet including device information of a user and resource provider information;
generating a token request push data packet including user information and the device information;
transmitting, to a user device, the token request push data packet, wherein the user device thereafter transmits a request to initiate token provisioning to a resource provider computer associated with the resource provider information;
receiving, from the resource provider computer, a provisioning request generated based on the request to initiate the token provisioning; and
transmitting, to a token service computer, the provisioning request including the token request push data packet, wherein, upon receiving the provisioning request, the token service computer determines token data using the device information and the user information from the token request push data packet and provides the token data to the resource provider computer.

16. A method comprising:
transmitting, by a user device operated by a user to an authorizing entity computer, device information of the user and resource provider information of a resource provider, wherein the authorizing entity computer thereafter generates and transmits, to a processing computer, an enrollment data packet including the device information and the resource provider information;
receiving, by the user device, a token request push data packet including user information and the device information; and
in response to the receiving the token request push data packet, transmitting, by the user device a request to initiate token provisioning to a resource provider computer associated with the resource provider information,
wherein the resource provider computer thereafter transmits, to the processing computer, a provisioning request generated based on the request to initiate the token provisioning,
wherein the processing computer transmits, to a token service computer, the provisioning request including the token request push data packet, and
wherein, upon receiving the provisioning request, the token service computer generates token data using the device information and the user information from the token request push data packet and provides the token data to the resource provider computer.

17. The method of claim 16, wherein the receiving the token request push data packet causes the user device to invoke a resource provider application associated with the resource provider computer on the user device.

18. The method of claim 17, wherein the resource provider computer authenticates the user via the resource provider application and based on the authentication of the user, transmits, to the processing computer, the provisioning request, wherein the provisioning request notifies the processing computer that the resource provider computer authorized an enrollment of the user.

19. The method of claim 16, wherein the token data comprises a token, and
wherein the token is stored by the resource provider computer to be used in a future interaction with respect to the user.

20. The method of claim 16, wherein the token data comprises at least one from among a token reference identifier and a token corresponding to a primary account number of the user.
